(19) United States
(12) Patent Application Publication
(10) Pub. No.: US 2004/0254849 A1
(43) Pub. Date: Dec. 16, 2004

(54) Method and system for the processing of order transactions

(75) Inventor: Manuel Brocke-Benz, West Chester, PA (US)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck Patent GmbH, Darmstadt (DE)

(21) Appl. No.: 10/626,866

(22) Filed: Jul. 25, 2003

(30) Foreign Application Priority Data
Jul. 25, 2002 (DE) 102 34 004.8

(51) Int. Cl. G06F 17/60

(52) U.S. Cl. 705/26; 705/1

(57) ABSTRACT

The present invention relates to a system for the processing of order transactions with a data memory, a recording device which is provided to record order data from a purchaser, a processing unit for the storage of recorded order data in the data memory. Furthermore, the present invention relates to a method for the processing of order transactions between a supplier and a purchaser, which has the steps of the recording of order data which consist of individual data fields, and transmission by the purchaser to the supplier, the creation of a file which contains data fields which represent at least some of the order data and the transmission of the file to the purchaser. In order to provide a cost-effective method and a system for the processing of order transactions between a supplier and a purchaser which is easy to implement and which can be used both in the B2C field and the B2B field, a simplified data exchange being possible in particular in the B2B field, through which the manual double entry of order data can be avoided, it is proposed according to the invention that a device be provided for the creation and issue of a file which contains data fields which represent at least some of the order data, and a transmission device for the transmission of the file to the purchaser.

The present invention relates to a method and a system for the processing of business transactions, in particular of order transactions. This means in particular an automation of the order transactions between businesses (B2B—Business to Business) but also between a business and a consumer (B2C—Business to Consumer).

Particularly in the field of business, often very complex accounting and control systems are used which are also called ERP systems. By Enterprise Resource Planning (ERP) is meant very generally software solutions which control and evaluate the running of the business, for example in the fields of logistics and sales, often however also finances and human resources. These systems create a clear and easily manageable link between the individual areas so that ERP systems are often regarded as indispensable control instruments for assisting business decisions.

However such systems only function if it is ensured that all business transactions are processed via the ERP system, which requires at least the regular input for example of all order transactions. The manual input of the data is however not only very time-consuming, but moreover also a constant source of errors which could call into question the decisions made on the basis of the data.

Therefore, particularly in the B2B field, it is extremely desirable to structure the business transactions such that if possible there is a direct communication or a direct exchange of data between the ERP systems of the participating business partners.

In particular in the B2B environment, there are already numerous solutions with which the execution of business transactions can be automated. An electronic data interchange (EDI) has already been used between businesses for many years. With EDI, the standardized, bilateral exchange of business data, such as e.g. orders, has already been carried out via networks. Files with rigidly structured data fields are exchanged between the businesses. In general this exchange require very costly proprietary networks which are also called Value Added Networks (VAN). This method was therefore also only used in a few larger businesses. The business processes have already been significantly accelerated with EDI and moreover the number of input errors which often occurred as a result of the manual processing of business transactions has been reduced.

More recently, EDI is being realized via the Internet with the help of so-called Virtual Private Networks (VPN). These networks are however very manufacturer-dependent in respect of their software architecture and also very expensive with the result that the possibilities for use are very limited.

There are already B2B solutions via which business relationships can be conducted between trading partners, which extend beyond actual order and purchase activities. These can range from the provision of data, the selection of products, the agreement of a specific goods quantity to the price and also settling payment. However all known ways of conducting business in the B2B field have the disadvantage that on both sides, i.e. on the side of the purchaser and the supplier, a correspondingly interlinked system must be provided, the development of which is however very time-consuming and expensive.

The processing of order and purchase transactions in the consumer market (B2C) via the Internet is in contrast largely unproblematic. This is due substantially to the fact that the private consumer does not keep accounts in which the orders and invoices must be entered and accepted. Nor is there in general any ERP system which can only accept deliveries if previously the orders have been correspondingly entered into the system.

Naturally it is possible in principle to also use the system tailored for consumers in the B2B field. Then the employee in charge of ordering must place the corresponding order via the Internet and enter the goods, the number of goods and also the goods price into the input mask offered by the supplier via the Internet. As however in the business field, the purchaser usually has an in-house accounting system and also an in-house ERP system, the purchaser must then enter the individual data once more in his in-house ERP environment. Quite apart from the fact that the time required for an order transaction is increased as a result, there is also the risk that the purchaser will make errors during the manual entry. This means that the systems developed for the B2C field have gained little acceptance in the B2B field.

Particularly smaller businesses therefore find it difficult to market their goods intended for other businesses via the Internet. Although they could resort to the conventional B2B solutions, this is only cost-effective between businesses with a specific minimum order volume. The significantly more economical B2C systems are in contrast usually not used by the corresponding employees in charge of the procurement of goods due to the additional work associated with same.

In many production and trading businesses however, electronic procurement has recently gained significantly in importance. This is due to the fact that as a result the process costs can be considerably reduced, the process quality and speed being simultaneously significantly increased. A single order transaction executed manually often results in costs of several hundred marks due to administrative activities alone, such as for example the procurement and filling out of order forms and the monitoring of deliveries, the manual reconciliation processes, such as e.g. the required number of signatures which are required for the authorization of an order transaction and the associated errors, such as for example incorrect or incomplete item numbers which can greatly delay the delivery process and may lead to costly follow-up processes. The average price of the ordered item is often only 20-30 DM.

It is therefore obvious that there is a demand for a cost-effective method and a system for the processing of business transactions.

The object of the invention is therefore to make available a cost-effective method and a system for the processing of order transactions between a supplier and a purchaser, which is easy to implement and which can be used both in the B2C field and the B2B field, a simplified data exchange being possible in particular in the B2B field, as a result of which the manual double entry of order data can be avoided.

This object is achieved in respect of the method in that the order data are recorded and transmitted by the purchaser to the supplier, a file is created which contains data fields which represent at least some of the order data and this file is transmitted to the purchaser.

By order data is meant for example details on the goods type, the number of goods, the goods price and also the payment and delivery conditions.

After completion of the order transaction or after the individual order data have been recorded, a file is created which contains data fields which contain at least the particularly relevant order data. This file is transmitted to the purchaser. The type of goods ordered, the quantity of goods ordered and the price for example are entered in the file. The purchaser need not now enter these data once again into his in-house accounting program, but can use the transmitted file to scan in the corresponding data automatically.

The method is particularly preferably used in a network such as e.g. the Internet. The file is preferably an ASCII file. ASCII stands for “American Standard Code for Information Interchange”. Text files (TXT files) but also HTML files (HyperText Markup Language) and XML files (Extensible Markup Language) are advantageously used.

The file is particularly preferably transmitted to the purchaser via e-mail. In addition to the e-mail transmission method, two further methods have established themselves:

1. The purchaser can download the said file himself via an access (usually via the Internet) to the supplier's system.

2. The purchaser can receive the said file automatically via an electronic dispatch process (e.g. FTP).

In both methods, the purchaser can determine whether he would like to receive the order data in separate files (one file per order) or combined into one file. In the latter case, the purchaser can choose the time periods (e.g. last week) from which the order data are to be combined.

The file is structured (with header data and item data) such that customer systems are capable of reading and processing the order data automatically.

To ensure that the processing of the transmitted file by the purchaser is as easy as possible, it is furthermore provided in a particularly preferred version of the method that before the creation of the file, some of the order data or some of the data fields are firstly selected by the user, a file then being created which contains at least the selected part of the order data. The purchaser can thus himself determine which data are to be transmitted to him in the file so that only those data fields of the order data which the purchaser can and must use in his in-house accounting or ERP system need be transmitted.

In a further particularly preferred version it is provided that the user can select the configuration of individual data fields of the order data, a file then being created in which the data fields of the order data are stored in the configuration selected by the user. It is also possible as a result of this measure for the user to adapt the created file to the requirements of his in-house accounting system.

In a further particularly expedient version of the method it is provided that the purchaser selects a file format, the file then being created in the format selected by the purchaser. In addition to the TEXT, HTML and XML formats already mentioned, files could also be created for example in database formats. Thus it is possible for example to give the purchaser the possibility to search between different database systems or ERP systems, the file then being created automatically in the format required by the corresponding database system or ERP system.

Furthermore it can be advantageous for example if it is provided that the purchaser can also select the data format of the individual data fields. Thus for example different date formats, such as e.g. “15.03.2000” or “2000-03-15” are often used depending on the system. Because the purchaser can select the format in which a date is to be entered into the data field, the file can be scanned and processed directly from the accounting or ERP system of the purchaser without further conversion.

In a particularly preferred version it is provided that the purchaser is identified before the creation of the file. This can be carried out for example by the entry of a user ID and/or a password.

In a further particularly preferred method it is provided that a purchaser profile is stored which allocates the data format chosen by the purchaser and/or the order data selected by the purchaser and/or the configuration of data fields selected by the purchaser in the file to the purchaser or corresponding identification data of the purchaser. This has the advantage that the purchaser need only specify once his desired file format including the configuration and the number of data fields. With each new order, provided the purchaser does not modify the purchaser profile, the file is then created using the data stored in the purchaser profile.

The created file can in principle be created in any desired format. Particularly preferred however is a simple text file or an ASCII file, as this file format can be processed by almost all commonly used systems. A further possibility is to create the file in the so-called XML format (Extensible Mark-up Language). With the help of this quite new language, rigid data structures as required in conventional languages can be overcome.

In a further particularly preferred method, the purchaser is likewise informed which format the created file has and/or which data fields are contained in the created file and/or in what sequence the individual data fields are configured in the created file. The purchaser can thus easily check whether the individual data fields are in his desired configuration. In addition, such information facilities the adaptation of the accounting system or the ERP system which may be necessary on the part of the purchaser. This communication can take place for example by the creation and transmission of a further file in which the corresponding data are entered.

In respect of the system, the object mentioned at the outset is achieved by a system for the processing of order transactions with a data memory, a recording device which is provided to record order data from a purchaser, a processing unit for the storage of recorded order data in the data memory, a device being provided according to the invention for the creation and output of a file which contains data fields which represent at least the selected order data, and a transmission device for the transmission of the file to the purchaser.

This transmission device can for example be e-mail dispatch via the Internet. Naturally, the file can also be sent to the purchaser by post on a non-volatile data carrier.

The recording device can be designed as desired. Thus it is possible for example for the purchaser to enter the corresponding data fields of the order data via the Internet using his keyboard into corresponding fields of an input mask. Alternatively, it could also be provided that the purchaser records at least some of the data using a bar-code scanner with which for example bar codes can be read from an order catalogue.

Advantageously, the recording device can be accessed via a data line such as e.g. a network, preferably an Intranet or the Internet. It is therefore not absolutely necessary for the purchaser to record the data fields at the goods supplier's site itself. The created file is preferably an ASCII file and is transmitted to the purchaser by e-mail.

In a particularly preferred version of the system, a selection device is furthermore provided with which the sequence of the data fields of the order data in the file can be specified. It is provided according to the invention that the selection device is designed to be accessible to the purchaser. Furthermore, the selection device can advantageously be provided so that the purchaser can specify which data fields of the order data are to be stored in the file.

Advantageously, an identification device is furthermore provided to identify the purchaser. The identification can take place for example by the entry of an identification number or a password, but also with the help of an electronically readable customer card, a device for recording a finger print or similar.

Further advantages, features and possible applications are illustrated using the following description of a preferred version.

The starting point for the present invention is a typical e-commerce ordering system for the B2C environment. The purchaser can make contact with the supplier's system via the Internet. The supplier's system is as a rule directly connected to the supplier's ERP system (Enterprise Resource Planning System, such as e.g. SAP R/3). The purchaser enters the order data into correspondingly provided data fields. Order data can be for example customer number, customer name, delivery address, products, prices, delivery dates etc. which are then displayed to the customer who has previously identified himself using his customer number and a password.

In an input mask, the purchaser can also select fields from a list of data which he requires for his in-house accounts or his in-house ERP system. Examples of data fields are: order number, order date, customer name, customer number, number of contact person, name of contact person, order reference, currency, language, payment conditions, but also goods-related data such as e.g. material number, material description, material number of the customer, order quantity, purchase unit, price per purchase unit, total price with/without discount, taxes, gross weight, net weight, weight per unit, volume, volume per unit, EAN number (European Article Number), etc. These data are stored in the manufacturer's ERP system. It is therefore not necessary for the purchaser to enter this plurality of data each time. Rather, the system according to the invention allocates the purchaser, after he has identified himself, the most recent purchaser profile used by him. After the purchaser has further optionally sorted the list of data fields in the sequence which is most favourable for processing in the accounting system or ERP system of the purchaser and optionally given them a specific desired file format, a file is created after the order transaction is concluded depending on the stored customer profile. Through the creation of the customer profile, the purchaser is in a position to specify the format and the contents of the file such that the file can be processed directly by the purchaser's ERP system. This file is transmitted to the purchaser for example by e-mail as an attachment to an order confirmation.

In particular if the file has been created as a text file, the customer can, if required, extend the file to include further data fields, such as for example a particular cost centre of the purchaser or a particular project number of the purchaser. The optionally correspondingly extended file can then be imported into the purchaser's system with the customary upload programs available.

In the application of the method, it has also been shown that the prepared files are very suitable to enable the customer to generate detailed statistics about the purchasing behaviour of the customer organization. The files can be processed easily by the customer, e.g. with PC programs such as MS Excel®.

With the proposed method, it is possible to modify a system developed specially for the B2C field easily and with little financial outlay such that it can easily be used in the B2B environment as well. The purchaser need enter the order data only once, with the result that the danger of incorrect manual entries is minimized.

Even without further versions, it is assumed that a person skilled in the art can use the above description to its fullest extent. The preferred versions and examples are therefore to be understood merely as a descriptive disclosure which is not limiting in any way whatsoever.

The full disclosure of all applications, patents and publications cited above or hereafter, and also the corresponding application DE 102 34 004.8, submitted on 25^{th} Jul. 2002, are included in this application by reference.

1. System for the processing of order transactions with a data memory, a recording device which is provided to record order data from a purchaser, a processing unit for the storage of recorded order data in the data memory, characterized in that a device is provided for the creation and output of a file which contains data fields which represent at least some of the order data, and a transmission device for the transmission of the file to the purchaser.

2. System according to claim 1, characterized in that the recording device has an access device on which the purchaser can gain access via a data line such as e.g. a network, preferably an Intranet or the Internet.

3. System according to claim 2, characterized in that it is provided that the file be transmitted to the purchaser as e-mail.

4. System according to claim 1, characterized in that the file is an ASCII file.

5. System according to claim 1, characterized in that a selection device is provided which can be used to select which order data are stored in the file.

6. System according to claim 1, characterized in that a selection device is provided with which the sequence of the data fields of the order data in the file can be specified.

7. System according to claim 5, characterized in that the selection device is designed to be accessible to the purchaser.

8. System according to claim 1, characterized in that an identification device is provided to identify the purchaser.

9. System according to claim 8, characterized in that a profile recording device is provided to record the parts of the order data desired by the purchaser and also the sequence of the order data in the file and to store the recorded profile data in the data memory, the profile data preferably being linked to identification data.

10. Method for the processing of business transactions between a supplier and a purchaser which contains the following steps:
1) Recording of order data which consist of individual data fields, and transmission from the purchaser to the supplier,
2) Creation of a file which contains data fields which represent at least some of the order data, and
3) Transmission of the file to the purchaser.

11. Method according to claim 10, characterized in that the order data are transmitted via a device for remote data transmission or a network, preferably the Internet.

12. Method according to claim 10, characterized in that the file is transmitted to the purchaser with the help of e-mail.

13. Method according to claim 10, which between step 1) and 2) also has the step:
1a) Selection of some of the order data by the purchaser,
a file which contains at least the selected part of the order data being created in step 2).

14. Method according to claim 10, which between step 1) and 2) also has the step:
1b) Selection of the configuration of individual data fields of the order data by the user,
a file in which the data fields of the order data are stored in the configuration selected by the user being created in step 2).

15. Method according to claim 10, which between step 1) and 2) also has the step:
1c) Selection of a file format by the purchaser,
the file being created in the format selected by the purchaser in step 2).

16. Method according to claim 10, characterized in that an identification of the purchaser takes place before step 2).

17. Method according to claim 10, characterized in that the following step is provided:
4) Storage of a purchaser profile which allocates to the purchaser the data format selected by the purchaser and/or the data fields of the order data selected by the purchaser and/or the configuration of the data fields in the file selected by the purchaser.

18. Method according to claim 17, characterized in that a file with the selected data format and/or with the order data selected by the purchaser and/or with the configuration of the data fields in the file selected by the purchaser is created in step 2) depending on the purchaser profile.

19. Method according to claim 10, wherein the purchaser is informed which format the file created in step 2) has and/or which data fields are contained in the file created in step 2) and/or in what sequence the individual data fields are configured in the file created in step 2).
